(19) United States
(12) Patent Application Publication
(10) Pub. No.: US 2026/0101109 A1
(43) Pub. Date: Apr. 9, 2026

(54) CONTROL APPARATUS, IMAGING MOVABLE UNIT, CONTROL METHOD, AND STORAGE MEDIUM

(71) Applicant: CANON KABUSHIKI KAISHA, Tokyo (JP)

(72) Inventor: SHOTA NIKI, Kanagawa (JP)

(21) Appl. No.: 19/306,105

(22) Filed: Aug. 21, 2025

(30) Foreign Application Priority Data
Oct. 9, 2024 (JP) 2024-176833

(51) Int. Cl. H04N 23/68; B64U 10/13; B64U 20/87; B64U 101/30

(52) U.S. Cl. CPC H04N 23/685; B64U 10/13; B64U 20/87; H04N 23/683; B64U 2101/30

(57) ABSTRACT

A control apparatus configured to control an imaging movable unit including a movable unit including a drive unit, an imaging unit mounted on the movable unit and configured to perform imaging, and an image stabilizing unit configured to perform image stabilization in a case where a position of the movable unit changes includes one or more memories storing instructions, and one or more processors that, upon execution of the instructions, operate to reduce a drive frequency of the drive unit during the imaging compared to that before the imaging, and control the drive unit so that the movable unit after the imaging moves toward a position of the movable unit before the imaging in a case where a position change amount of the movable unit during the imaging exceeds a first predetermined amount by which the image stabilization can be performed by the image stabilizing unit.

### BACKGROUND

### Field of the Technology

The aspect of the disclosure relates to one or more embodiments of control of a movable unit that can perform imaging.

### Description of the Related Art

Drones and other movable units may have cameras for aerial photography and the like. Japanese Patent Application Laid-Open No. 2023-051234 discloses a movable unit having a camera and an image stabilizing (gimbal) mechanism for image stabilization during imaging.

In a drone, high-frequency vibrations are generated when the propellers are driven. On the other hand, the image stabilizing apparatus is primarily used to reduce image shake caused by low-frequency vibrations such as a shake caused by the drone's flight, so image shake caused by high-frequency vibrations remains in a captured image.

### SUMMARY

One or more embodiments of a control apparatus according to one or more aspects of the disclosure configured to control an imaging movable unit including a movable unit including a drive unit, an imaging unit mounted on the movable unit and configured to perform imaging, and an image stabilizing unit configured to perform image stabilization in a case where a position of the movable unit changes may include one or more memories storing instructions, and one or more processors that, upon execution of the instructions, operate to perform first processing for reducing a drive frequency of the drive unit during the imaging compared to that before the imaging, and perform second processing for controlling the drive unit so that the movable unit after the imaging moves toward a position of the movable unit before the imaging in a case where a position change amount of the movable unit during the imaging exceeds a first predetermined amount by which the image stabilization can be performed by the image stabilizing unit.

One or more embodiments of a control apparatus according to one or more aspects of the disclosure configured to control an imaging movable unit including a movable unit including a drive unit, an imaging unit mounted on the movable unit and configured to perform imaging, and an image stabilizing unit configured to perform image stabilization caused by a position of the movable unit changes may include one or more memories storing instructions, and one or more processors that, upon execution of the instructions, operate to perform first processing for reducing a drive frequency of the drive unit during the imaging compared to that before the imaging, and reduce the drive frequency in the first processing so that a position change amount of the movable unit associated with a reduced drive frequency does not exceed a first predetermined amount by which the image stabilization can be performed by the image stabilizing unit.

One or more imaging movable unit may include one or more control apparatuses in accordance with one or more other aspects of the disclosure. One or more control methods corresponding to the above one or more control apparatuses also constitute another aspect of the disclosure. A storage medium storing a program that causes a computer to execute the above one or more control methods also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a schematic diagram and a block diagram of a drone imaging system according to a first embodiment.

FIGS. 2A, 2B, and 2C illustrate an operation during continuous shooting according to the first embodiment.

FIGS. 3A and 3B illustrate perspective correction according to the first embodiment.

FIG. 4 is a flowchart illustrating continuous shooting processing in the first embodiment.

FIG. 5 is a block diagram of a drone imaging system according to a second embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

### First Embodiment

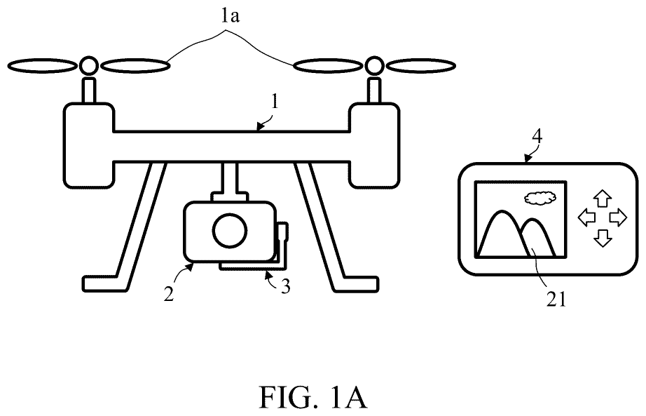

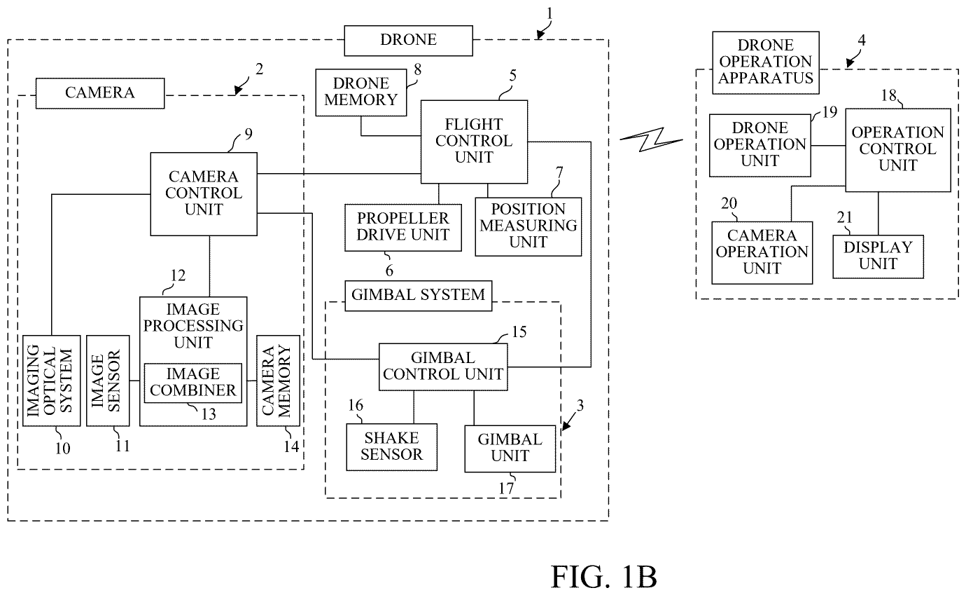

FIG. 1A illustrates an outline of an imaging drone system that includes an imaging drone (imaging movable unit) in which a camera 2 as an imaging unit and a gimbal system 3 as an image stabilizing unit are mounted on a drone 1, which is an unmanned flying object as a movable unit, and a drone operation apparatus 4. FIG. 1B illustrates the electrical configuration of the imaging drone system. The movable unit is not limited to a drone, but may be another movable unit such as a manned airplane, an automobile, and a ship. The image stabilizing unit is not limited to a gimbal system provided on the drone, but may be an optical image stabilizing unit that moves a lens or image sensor in a camera, or an electronic image stabilizing unit that shifts a cutout range in a captured image. The gimbal system and image stabilizing unit in the camera may be used together. This embodiment uses the camera 2 in which a lens unit is integrated with the camera body, but may use a camera in which the lens unit is attachable to and detachable from the camera body.

In the drone 1 illustrated in FIGS. 1A and 1B, reference numeral 1a denotes a plurality of propellers, reference numeral 5 denotes a flight control unit as a control apparatus, reference numeral 6 denotes a propeller drive unit, reference numeral 7 denotes a position measuring unit, and reference numeral 8 denotes a drone memory. In the camera 2, reference numeral 9 denotes a camera control unit, reference numeral 10 denotes an imaging optical system, reference numeral 11 denotes an image sensor, reference numeral 12 denotes an image processing unit, reference numeral 13 denotes an image combiner in the image processing unit 12, and reference numeral 14 denotes a camera memory. In the gimbal system 3, reference numeral 15 denotes a gimbal control unit, reference numeral 16 denotes a shake sensor, and reference numeral 17 denotes a gimbal drive unit. In the drone operation apparatus 4, reference numeral 18 denotes an operation control unit, reference numeral 19 denotes a drone operation unit, reference numeral 20 denotes a camera operation unit, and reference numeral 21 denotes a display unit.

The propeller drive unit 6 provided to the drone 1 includes the propellers 1a for flying the drone 1 in response to a flight control signal from the flight control unit 5, and an unillustrated motor configured to rotate the propellers 1a.

The position measuring unit 7 acquires position information on three-dimensional coordinates as the current position of the drone 1 by communicating with a Global Navigation Satellite System (GNSS) such as the Global Positioning System (GPS). Using the position information acquired by the position measuring unit 7 enables can fly the drone 1 to a variety of target positions or to maintain a hovering state at a fixed position.

The drone memory 8 records the position information acquired by the position measuring unit 7, and records information about the drone 1 in advance, such as the total weight of the drone 1 including the camera 2 and gimbal system 3, and the maximum correction angle of the gimbal system 3. The flight control unit 5 generates a flight control signal for the propeller drive unit 6 using the information recorded in the drone memory 8.

In the camera 2, the imaging optical system 10 images light from an object. The image sensor 11 is a photoelectric conversion element such as a CCD sensor or a CMOS sensor, and photoelectrically converts (captures) an object image formed by the imaging optical system 10. The image processing unit 12 has an A/D converter, a white balance adjustment circuit, a gamma correction circuit, an interpolation calculation circuit, etc., and generates an image from an imaging signal from the image sensor 11. The image processing unit 12 also performs compression processing of images and audio.

The image combiner 13 performs image combination processing to generate a combined image in a case where an imaging mode for image combination is selected by the camera operation unit 20 in the drone operation apparatus 4. An imaging mode that performs image combination includes, for example, a high dynamic range (HDR) imaging mode that combines a plurality of captured images with different exposures to generate a combined image with a wide dynamic range, and a high-resolution imaging mode that combines a plurality of captured images obtained by performing imaging while moving the image sensor 11 in a direction perpendicular to the optical axis in units of less than the pixel pitch to generate a high-resolution combined image.

The camera memory 14 records compressed captured images, combined images, and audio (collectively referred to as image information hereinafter).

The camera control unit 9 controls imaging by the image sensor 11. The camera control unit 9 also controls the driving of the zoom lens, focus lens, aperture stop, etc. (not illustrated) in the imaging optical system 10 according to an imaging operation such as zooming, focusing, and aperture adjustment using the camera operation unit 20 of the drone operation apparatus 4. The camera control unit 9 also transmits image information to the drone operation apparatus 4 and displays an image corresponding to the image information on the display unit 21.

The gimbal unit 17 in the gimbal system 3 includes a gimbal mechanism that holds the camera 2 rotatably (movably) in the pitch (vertical), yaw (horizontal) and roll directions, and three motors that drive the gimbal mechanism to rotate the camera 2 in the above three directions. The shake sensor 16 includes a vibration gyro or the like, and detects rotational shake in the pitch, yaw and roll directions among the shakes applied to the drone 1 (i.e., the camera 2). The gimbal control unit 15 controls the three motors in the gimbal unit 17 so as to obtain a correction angle corresponding to the magnitude of the rotational shake detected by the shake sensor 16. Thereby, the image stabilization can be performed in the pitch, yaw and roll directions. The gimbal system 3 is adjusted to correct image shake caused by low-frequency shake such as shaking associated with the flight of the drone 1.

In the drone operation apparatus 4, the drone operation unit 19 and the camera operation unit 20 are operated by a user (operator) to remotely control the drone 1 and the camera 2. When the operation control unit 18 detects a user's operation on the drone operation unit 19, it transmits a drone operation signal to the flight control unit 5 of the drone 1. The flight control unit 5 controls the flight of the drone 1 by controlling the propeller drive unit 6 based on the received drone operation signal and the position information from the position measuring unit 7.

When the operation control unit 18 detects a user's operation on the camera operation unit 20, it transmits a camera operation signal to the camera control unit 9 in the camera 2. The camera control unit 9 controls the operations of the imaging optical system 10, the image sensor 11, and the image processing unit 12 based on the received camera operation signal. As described above, the display unit 21 displays an image in accordance with the image information transmitted from the camera 2 so that the user can view it.

The flight control unit 5, the camera control unit 9, and the gimbal control unit 15 are connected communicably to each other, and can control the flight of the drone 1 and the drive of the gimbal unit in accordance with the imaging timing of the camera 2. The camera control unit 9 can also record metadata including information on image stabilization such as a correction angle of the gimbal system 3 in the camera memory 14 together with the image information.

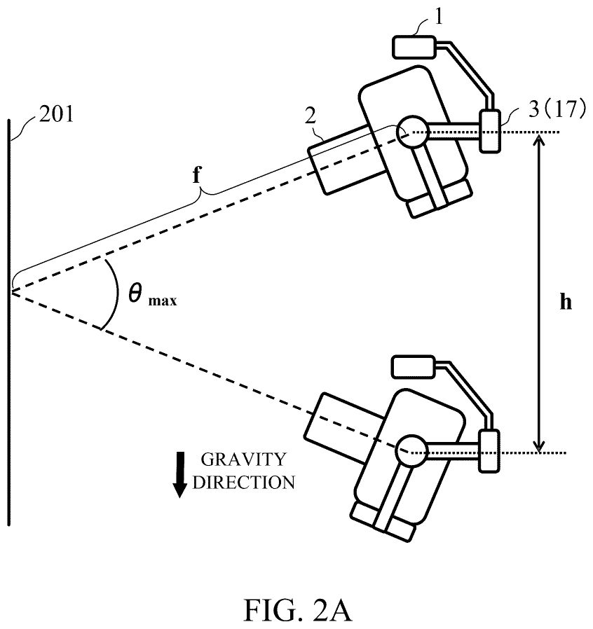

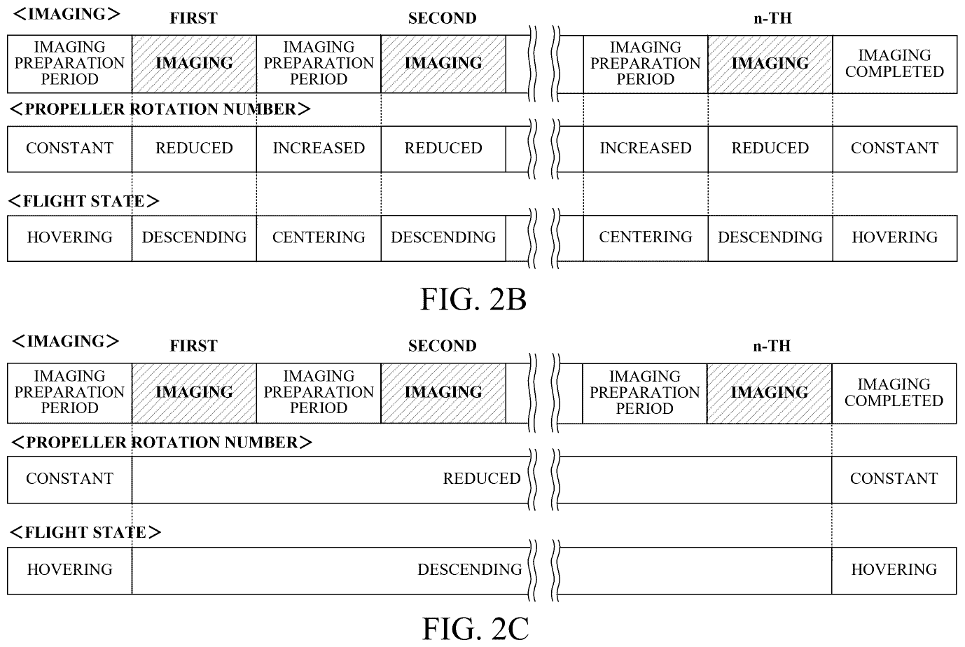

Referring now to FIGS. 2A, 2B, and 2C, a description will be given of the control of the number of revolutions of the propellers 1a (the drive speed of the propeller drive unit 6) of the drone 1 and the flight state in each imaging during continuous shooting to acquire a plurality of (n) captured images in this embodiment and in the imaging preparation period. The plurality of captured images are acquired to generate the combined image described above. The number of revolutions of the propellers 1a corresponds to the drive frequency of the propeller drive unit 6, and the vibrations generated in the drone 1 can be said to be vibrations with a frequency corresponding to the drive frequency of the propeller drive unit 6. The drive frequency of the propeller drive unit 6 may correspond to the drive frequency of a motor (not illustrated).

FIG. 2A illustrates a range h in the gravity direction in which image stabilization can be provided by the gimbal system 3 (image stabilizing range: referred to as a correctable range hereinafter). As described later, this embodiment reduces the propeller rotation number (number of propeller rotations or revolutions, or propeller revolutions per minutes (RPM)) of the drone 1 for each imaging during continuous shooting relative to a state before imaging (imaging preparation period). This reduction in the propeller rotation number (propeller rotation speed) causes a position of the drone 1 to change (descend). In a case where a position change amount of the drone 1 is within the correctable range h, the gimbal system 3 can perform image stabilization.

FIG. 2B illustrates the first imaging to the n-th imaging, propeller rotation number, and flight state in a case where the drone 1 is centered during continuous shooting. Centering refers to controlling the propeller rotation number so as to move the drone 1, whose position has changed from the start position of the continuous shooting, toward the start position (in a direction approaching the start position). More specifically, this action includes returning the drone 1 to the start position within the correctable range or moving it closer to the start position, and moving it from a position outside the correctable range into a position within the correctable range. FIG. 2C illustrates the first imaging to the n-th imaging, propeller rotation number, and flight state in a case where the drone 1 is not centered.

This embodiment determines whether or not to center the drone 1 during continuous shooting. In a case where the propellers (motor) 1a of the drone 1 are to be driven at a high rotation speed, the high-frequency vibration generated by this drive causes high-frequency image blur that cannot be corrected by the gimbal system 3 in the plurality of captured images obtained by continuous shooting for a combined image. Thus, reducing the propeller rotation number to a predetermined rotation speed or lower in the low-frequency range where image stabilization can be provided by the gimbal system 3 only in each imaging (exposure) during continuous shooting can suppress the high-frequency image blur.

However, reducing the propeller rotation number to the predetermined rotation speed or lower may change (descend) the position of the drone 1 due to gravity. This embodiment determines (selects) whether or not to perform centering according to the position change amount.

In FIG. 2A, reference numeral 201 denotes an object. In a case where continuous shooting is performed, the total imaging time required from the start of the first imaging to the end of the n-th imaging can be calculated from the shutter speed and the number of images captured in one imaging that has been set. Using the calculated total imaging time can determine the position change amount (descending amount) Δx of the drone 1 during the total imaging time (i.e., during continuous shooting) when the propeller rotation number is reduced to the predetermined rotation speed or lower in each imaging during the continuous shooting.

As illustrated in FIG. 2A, assume that f is a distance from the camera 2 to the object at the center of the imaging angle of view when the gimbal unit 17 is driven to the maximum correction angle, and θₘₐₓ is a maximum correction angle at which the gimbal unit 17 can provide image stabilization. Then, the correction range h in the pitch direction in which the gimbal unit 17 can provide image stabilization is calculated by the following equation (1):

$$h = 2 \times f \times sin ( {θ}_{max} / 2 ) \qquad ( 1 )$$

The method of calculating the correctable range h is not limited to this example, and it may be calculated using the distance from the camera 2 to the object at the center of the imaging angle of view when the camera 2 and the object are directly facing each other. In a case where the position change amount Δx and the correction range h are compared, if Δx≥h, image shake that cannot be corrected by the gimbal system 3 remains in the captured image, and therefore centering of the drone 1 is required during the imaging preparation period between two imaging operations during continuous shooting.

On the other hand, if Δx≤h, continuous shooting is completed within the range h where image stabilization can be provided by the gimbal system 3, so centering is not necessary. Centering increases the total imaging time, and there is a risk that the accuracy of the position information will deteriorate due to sensor drift of the position measuring unit 7, etc. Thus, the number of centering operations may be limited (set) to the minimum necessary. Accordingly, this embodiment determines whether or not to center the drone 1 based on the comparison result of the position change amount Δx and the predetermined amount (a first predetermined amount H1 described later) set according to the correctable range h.

In FIG. 2B, during the imaging preparation period before the start of continuous shooting, the drone 1 is in a hovering state, and the propeller rotation number is also constant. In a case where the first imaging is started, the propeller rotation number is reduced to reduce high-frequency vibration applied to the camera 2 (first processing). As a result, the drone 1 descends. When the first imaging is completed and the second imaging preparation period starts, the propeller rotation number is increased and the drone 1 is centered (second processing). When centering is completed, the second imaging is started, and the propeller rotation number is reduced again.

The above control is repeated until the n-th imaging is performed, and after the n-th imaging is completed, the drone 1 is in a hovering state.

Centering does not have to be performed for each imaging, and may be performed after at least one of the multiple imaging in the continuous shooting. For example, centering may be performed every m-th imaging, which is multiple imaging, in the imaging preparation period between the (a×m)-th imaging (a=1, 2, 3, . . . ) and the (a×m+1)-th imaging.

In FIG. 2C, during the imaging preparation period before the continuous shooting is started, the drone 1 is in a hovering state as in FIG. 2B. When the first imaging starts, the propeller rotation number is reduced, and as a result, the drone 1 descends. Since no centering is performed, the drone 1 continues to descend during the second imaging preparation period, and the second imaging is performed. The drone 1 continues to descend until the n-th imaging is completed, and returns to a hovering state after the n-th imaging is completed. The drone 1 may be in a hovering state during the imaging preparation period in a case where no centering is performed.

Thus, this embodiment determines whether to perform centering based on the position change amount Δx of the drone 1 during the total imaging time of the continuous shooting, and can perform continuous shooting for image combination while suppressing the accuracy deterioration of the position measuring unit 7 due to an increase in the total imaging time.

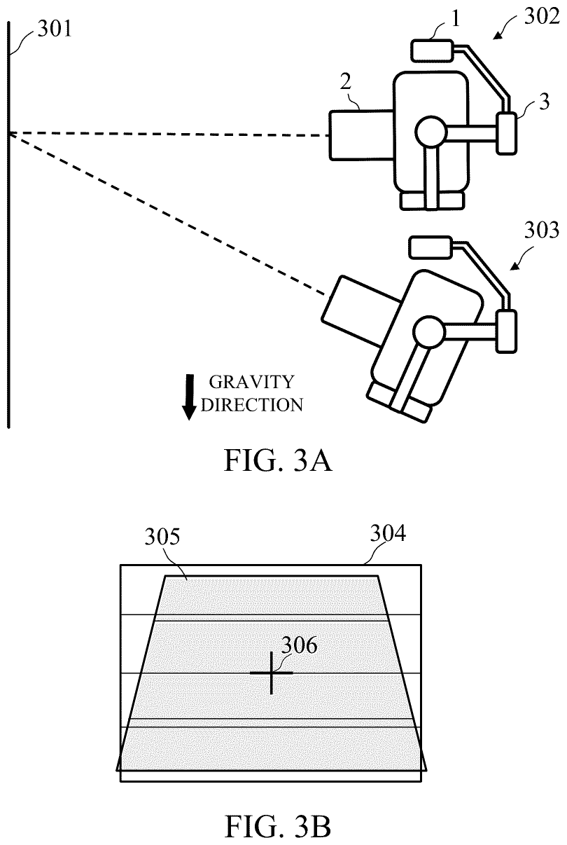

Next, the image combination processing according to this embodiment will be described with reference to FIGS. 3A and 3B. FIG. 3A illustrates the position change in the gravity direction of the drone 1 (camera 2) during continuous shooting and the operation of the gimbal system 3. FIG. 3B illustrates captured images obtained by imaging using the drone 1 at two different positions. Reference numeral 301 denotes an object, and reference numeral 302 denotes a first position of the drone 1 where the camera 2 faces the object 301 in the gravity direction. Reference numeral 303 denotes a second position where the drone 1 descends from the first position 302. The second position 303 indicates a position within a range where image stabilization can be provided by the gimbal system 3 and where the n-th imaging is performed. Reference numeral 304 denotes an image obtained by imaging at the first position 302, and reference numeral 305 denotes an image obtained by imaging at the second position 303. Reference numeral 306 denotes the center of each image.

At the second position 303, the orientation of the camera 2 is changed by the gimbal system 3 to face diagonally upwards in order to obtain the image 305 having the same center 306 as that of the image 304 obtained at the first position 302. The image 305 obtained at the second position 303 has perspective distortion according to the orientation of the camera 2 (i.e., the relative position between the object 301 and the drone 1). Hence, when these images 304 and 305 are combined, it is necessary to correct the perspective distortion of the image 305 (referred to as perspective correction hereinafter).

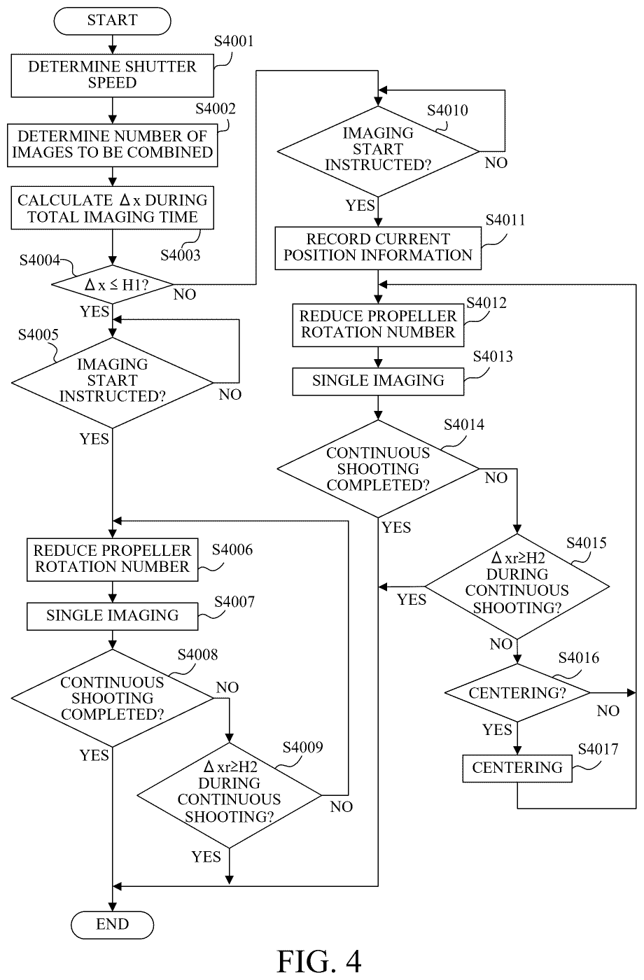

A flowchart in FIG. 4 illustrates processing (a control method) to be executed by the flight control unit 5 and the camera control unit 9, each of which is constituted by a computer (including one or more memories storing instructions and one or more processors that, upon execution of the instructions, operate to perform the above processing), according to a computer program in this embodiment. Here, as described above, the processing is illustrated for the case where the continuous shooting for image combination in the camera 2 is started from a hovering state at the first position (start position) of the drone 1.

In step S4001, the camera control unit 9 determines a shutter speed for each imaging during continuous shooting based on a shutter speed input by the user.

Next, in step S4002, the camera control unit 9 determines the number of images to be captured for image combination (number of images combined), that is, the number of images captured in continuous shooting, based on the number of images to be combined by the user.

Next, in step S4003, the flight control unit 5 receives information on the shutter speed and the number of images to be combined from the camera control unit 9, and calculates (acquires) a position change amount Δx of the drone 1 during the total imaging time obtained from them. More specifically, the position change amount Δx during the total imaging time is calculated based on the total weight of the drone 1 recorded in the drone memory 8 and a reduced amount in the propeller rotation number from the hovering state to or lower than the predetermined rotation speed in the low-frequency range described above.

A reduced amount in the propeller rotation number at this time can be set according to the shutter speed of the camera 2. For example, in a case where the shutter speed is short, an image blur amount included in a captured image tends to be small even if the position change amount is large, so a reduced amount in the propeller rotation number may be set to be large. On the other hand, in a case where the shutter speed is long, an image blur amount included in a captured image also increases if the position change amount is large, so the reduced amount in the propeller rotation number may be set to be smaller than that in a case where the shutter speed is short. In this case, processing may be performed such that the reduced amount in the propeller rotation number is set to or lower than a threshold value set according to the shutter speed as the maximum permissible value. Instead of the reduced amount in the propeller rotation number, a position change amount Δx may be calculated using the reduced propeller rotation number (target rotation speed).

Next, in step S4004, the flight control unit 5 compares the position change amount Δx of the drone 1 during the total imaging time with a first predetermined amount H1 set according to the correctable range h by the gimbal system 3. The first predetermined amount H1 may be the same as a position change amount corresponding to the correctable range h, or may be a position change amount set slightly smaller than that (such as 90%). In a case where the position change amount Δx is equal to or smaller than the first predetermined amount H1, the processing of step S4005 is performed, and in a case where the position change amount Δx is larger than the first predetermined amount H1, the processing of step S4010 is performed.

In step S4005, the camera control unit 9 determines whether or not a command to start continuous shooting has been input by the user. In a case where a command to start has been input, the processing of step S4006 is performed, and if not, the determination in this step is repeated.

In step S4006 (first step), the flight control unit 5 reduces the propeller rotation number in the propeller drive unit 6 by the reduced amount described above in step S4003.

Next, in step S4007, the camera control unit 9 performs single imaging in the continuous shooting.

Next, in step S4008, the camera control unit 9 determines whether or not the continuous shooting has been completed. In a case where the continuous shooting has been completed, the flow ends. In a case where the continuous shooting has not yet been completed, the processing of step S4009 is performed.

In step S4009, the flight control unit 5 compares an actual position change amount Δxr of the drone 1 during continuous shooting, acquired by at least one of the position measuring unit 7 and the shake sensor 16, with a second predetermined amount H2 set according to the correctable range h. This comparison is performed based on the actual position change of the drone 1 due to external factors such as strong winds. The second predetermined amount H2 may be the same as the first predetermined amount H1 described above, or it may be set to a value different from the first predetermined amount H1 (such as 90% of the first predetermined amount H1). In a case where the actual position change amount Δxr is equal to or greater than the second predetermined amount H2, this flow ends. If not, the flow returns to step S4006, and the propeller rotation number reduced in the previous step S4006 is maintained (third processing).

On the other hand, in step S4010, the camera control unit 9 determines whether or not a command to start continuous shooting has been input by the user. In a case where a command to start imaging has been input, the processing of step S4011 is performed, and if not, the determination in this step is repeated.

In step S4011, the flight control unit 5 records the position information (three-dimensional coordinates) of the drone 1 acquired by the position measuring unit 7 in the drone memory 8.

Next, in step S4012 (first step), the flight control unit 5 reduces the propeller rotation number in the propeller drive unit 6 by the reduced amount described above in step S4003.

Next, in step S4013, the camera control unit 9 performs single imaging in the continuous shooting.

Next, in step S4014, the camera control unit 9 determines whether the continuous shooting has been completed. In a case where the continuous shooting has been completed, this flow ends. In a case where the continuous shooting has not yet been completed, the processing of step S4015 is performed.

In step S4015, the flight control unit 5 compares the actual position change amount Δxr of the drone 1 during the continuous shooting acquired by at least one of the position measuring unit 7 and the shake sensor 16 with the second predetermined amount H2, as in step S4009. In a case where the actual position change amount Δxr during continuous shooting becomes equal to or larger than the second predetermined amount H2 due to an external factor or the like, the subsequent continuous shooting is stopped and this flow ends, otherwise, the processing of step S4016 is performed.

In step S4016, the flight control unit 5 determines whether or not to perform centering. That is, in a case where centering is to be performed every predetermined number of times (1 or m times) of imaging, it determines whether or not to perform centering after the current imaging. In a case where centering is to be performed, the processing of step S4017 is performed, and if not, the flow returns to step S4012. At this time, in step S4012, the propeller rotation number reduced in the previous step S4012 is maintained.

In step S4017 (second step), the flight control unit 5 increases the propeller rotation number in the propeller drive unit 6 to perform centering so that the drone 1 moves (ascends) toward the first position indicated by the position information recorded in step S4011. Then, the flow returns to step S4012, and the propeller rotation number is reduced for the next imaging.

As described above, this embodiment performs centering only when the position change amount Δx of the drone 1 due to the reduced propeller rotation number during continuous shooting exceeds the correctable range h. Thereby, centering can provide continuous shooting with reduced image blur while suppressing the influence of sensor drift in the position measuring unit 7 caused by the longer total imaging time for continuous shooting.

### Second Embodiment

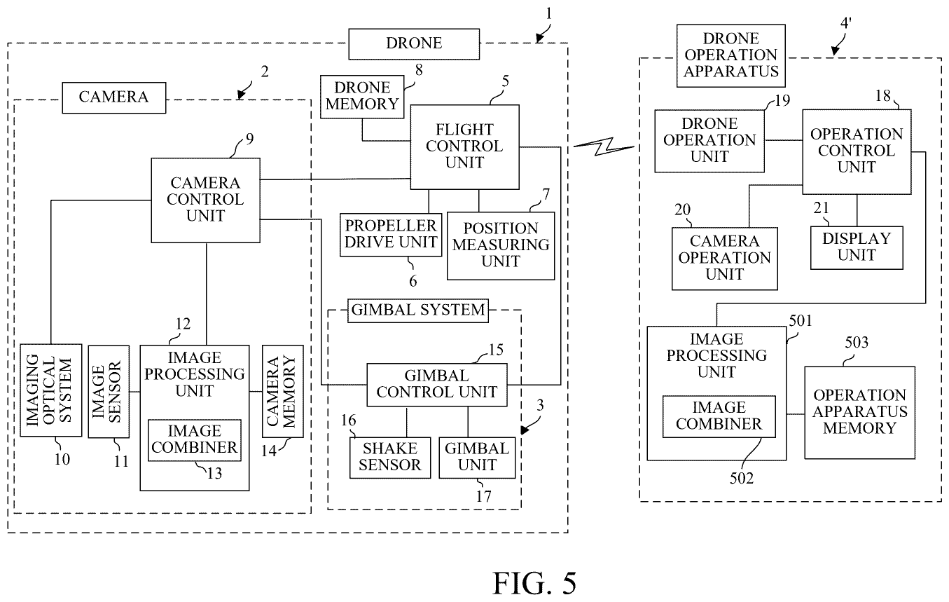

FIG. 5 illustrates the electrical configuration of a drone imaging system according to a second embodiment. The drone 1, camera 2, and gimbal system 3 in this embodiment are the same as those in the first embodiment. In this embodiment, a drone operation apparatus 4′ as an external device includes an image processing unit 501 including an image combiner 502, and an operation apparatus memory 503.

The operation control unit 18 of the drone operation apparatus 4′ receives image information (a plurality of captured images generated by continuous shooting) recorded in the camera memory 14 in the camera 2 from the camera control unit 9 and inputs it into the image processing unit 501. The image combiner 502 in the image processing unit 501 performs image combination processing to combine a plurality of captured images, and generates a combined image.

The operation control unit 18 records the combined image in the operation apparatus memory 503 and displays it on the display unit 21.

The image combiner may be provided in an external device, such as a personal computer, different from the camera 2.

By performing the image combination processing outside the camera 2 as in this embodiment, it is not necessary to perform the image combination processing within the camera 2. As a result, the power consumption of the drone imaging system including the camera 2 can be reduced, and aerial photography for longer periods of time can be achieved.

In the above embodiments, a flight control unit (control apparatus) mounted on the drone controls the flight state during continuous shooting (reducing the propeller rotation number, centering, etc.). Alternatively, a control apparatus as a personal computer not mounted on the drone or a control apparatus mounted on a drone operation apparatus may perform the above control via communication with the drone.

In the above embodiments, the propeller rotation number during continuous shooting is controlled to obtain a plurality of captured images to be combined. Alternatively, a similar control of the propeller rotation number may be performed in moving image capturing.

In the above embodiments, the propeller rotation number is reduced to a low-frequency range where image stabilization can be provided by the gimbal system during continuous shooting, and centering is performed when the position change amount of the drone exceeds a first predetermined amount according to the correctable range. In contrast, the propeller rotation number may not be reduced to the low-frequency range described above if the image blur caused by the propeller rotation can be reduced by reducing it even slightly. In this case, the propeller rotation number may be reduced so that the position change amount of the drone does not exceed the first predetermined amount. Even if hovering is possible at a propeller rotation number that does not generate high-frequency vibration that makes difficult to correct image blur, the propeller rotation number may be reduced during continuous shooting. In that case, in addition to suppressing image blur caused by high-frequency vibration of the movable unit, power consumption for the propeller drive can be suppressed.

In the above embodiments, a drone uses a method of rotating the propellers as a drive method, but a drone may use a method of flapping wings such as an ornithopter method. Such a method may control the frequency at which the wings flap by changing the drive frequency of the drive unit. The driving method of the drone is not limited to the above example, and may be any drive method that generates vibrations in the drone.

For example, the gimbal system performs image stabilization in the low-frequency range, but such control may be performed in a case where image stabilization can be provided in a frequency range higher than the low-frequency range by an optical or electronic image stabilizing unit built in the camera. Reducing the propeller rotation number so as not to exceed the first predetermined amount is also the processing performed in steps S4004 to S4007 described in the first embodiment (FIG. 4).

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment according to the disclosure can reduce image blur caused by high-frequency vibrations of a movable unit.

This application claims the benefit of Japanese Patent Application No. 2024-176833, which was filed on Oct. 9, 2024, and which is hereby incorporated by reference herein in its entirety.

What is claimed is:

1. A control apparatus configured to control an imaging movable unit including a movable unit including a drive unit, an imaging unit mounted on the movable unit and configured to perform imaging, and an image stabilizing unit configured to perform image stabilization in a case where a position of the movable unit changes, the control apparatus comprising:
one or more memories storing instructions; and
one or more processors that, upon execution of the instructions, operate to:
perform first processing for reducing a drive frequency of the drive unit during the imaging compared to that before the imaging, and
perform second processing for controlling the drive unit so that the movable unit after the imaging moves toward a position of the movable unit before the imaging in a case where a position change amount of the movable unit during the imaging exceeds a first predetermined amount by which the image stabilization can be performed by the image stabilizing unit.

2. The control apparatus according to claim 1, wherein the one or more processors operate to perform the second processing in a case where the position change amount acquired before the imaging exceeds the first predetermined amount.

3. The control apparatus according to claim 2, wherein the one or more processors operate to acquire the position change amount before the imaging based on a time required for the imaging, a weight of the imaging movable unit, and a reduced amount in the drive frequency or a reduced drive frequency.

4. The control apparatus according to claim 1, wherein the one or more processors operate to perform the second processing in a case where the position change amount from a start to an end of continuous shooting in which the imaging is performed multiple times exceeds the first predetermined amount.

5. The control apparatus according to claim 4, wherein the one or more processors operate to:
perform the first processing for each imaging in multiple imaging, and
perform the second processing after at least one of the multiple imaging.

6. The control apparatus according to claim 1, wherein the one or more processors operate to set a reduced amount in the drive frequency in the second processing according to a shutter speed in the imaging.

7. The control apparatus according to claim 1, wherein the one or more processors operate to perform third processing for maintaining the drive frequency reduced by the first processing even after the imaging in a case where the position change amount is smaller than the first predetermined amount.

8. The control apparatus according to claim 1, wherein the one or more processors operate to stop subsequent imaging in a case where an actual position change amount of the movable unit during the imaging exceeds a second predetermined amount by which the image stabilization can be performed by the image stabilizing unit.

9. A control apparatus configured to control an imaging movable unit including a movable unit including a drive unit, an imaging unit mounted on the movable unit and configured to perform imaging, and an image stabilizing unit configured to perform image stabilization caused by a position of the movable unit changes, the control apparatus comprising:
one or more memories storing instructions; and
one or more processors that, upon execution of the instructions, operate to:
perform first processing for reducing a drive frequency of the drive unit during the imaging compared to that before the imaging, and
reduce the drive frequency in the first processing so that a position change amount of the movable unit associated with a reduced drive frequency does not exceed a first predetermined amount by which the image stabilization can be performed by the image stabilizing unit.

10. The control apparatus according to claim 1, wherein the movable unit is a flying object configured to fly by rotating a propeller, and
wherein the drive frequency is the number of rotations of the propeller.

11. The control apparatus according to claim 1, wherein the image stabilizing unit is at least one of an image stabilizing unit provided to the movable unit and configured to movably hold the imaging unit and an image stabilizing unit provided within the imaging unit.

12. An imaging movable unit comprising:
the control apparatus according to claim 1;
the movable unit;
the imaging unit; and
the image stabilizing unit.

13. An imaging movable unit comprising:
the control apparatus according to claim 9;
the movable unit;
the imaging unit; and
the image stabilizing unit.

14. A control method configured to control an imaging movable unit including a movable unit including a drive unit, an imaging unit mounted on the movable unit and configured to perform imaging, and an image stabilizing unit configured to perform image stabilization in a case where a position of the movable unit changes, the control method comprising:
reducing a drive frequency of the drive unit during the imaging compared to that before the imaging; and
controlling the drive unit so that the movable unit after the imaging moves toward a position of the movable unit before the imaging in a case where a position change amount of the movable unit during the imaging exceeds a first predetermined amount by which the image stabilization can be performed by the image stabilizing unit.

15. A control method configured to control an imaging movable unit including a movable unit including a drive unit, an imaging unit mounted on the movable unit and configured to perform imaging, and an image stabilizing unit configured to perform image stabilization in a case where a position of the movable unit changes, the control method comprising:
performing first processing for reducing a drive frequency of the drive unit during the imaging compared to that before the imaging, and
reducing the drive frequency in the first processing so that a position change amount of the movable unit associated with a reduced drive frequency does not exceed a first predetermined amount by which the image stabilization can be performed by the image stabilizing unit.

16. A non-transitory computer-readable storage medium storing a program that causes a computer to execute the control method of claim 14.

17. A non-transitory computer-readable storage medium storing a program that causes a computer to execute the control method of claim 15.
